(19) United States
(12) Patent Application Publication
(10) Pub. No.: US 2024/0411182 A1
(43) Pub. Date: Dec. 12, 2024

(54) DISPLAY SYSTEM AND GLASSES

(71) Applicant: Japan Display Inc., Tokyo (JP)

(72) Inventor: Kentaro OKUYAMA, Tokyo (JP)

(73) Assignee: Japan Display Inc., Tokyo (JP)

(21) Appl. No.: 18/675,528

(22) Filed: May 28, 2024

(30) Foreign Application Priority Data
Jun. 6, 2023 (JP) 2023-093170

(51) Int. Cl. G02F 1/13363; G02B 27/01; G02F 1/1333; G02F 1/1347

(52) U.S. Cl. CPC G02F 1/133638; G02B 27/0172; G02F 1/133365; G02F 1/13471; G02B 2027/0178

(57) ABSTRACT

According to one embodiment, a display system includes a first display panel having a first surface, a second surface on a side opposite to the first surface, and a first display area that is visibly recognizable from the first surface side and the second surface side, and an optical element overlapping with a part of the first display area. The optical element includes at least one of a polarizer absorbing linearly polarized light and a retardation element imparting a ½-wavelength phase difference to transmitted linearly polarized light.

### CROSS-REFERENCE TO RELATED APPLICATIONS

This application is based upon and claims the benefit of priority from Japanese Patent Application No. 2023-093170, filed Jun. 6, 2023, the entire contents of which are incorporated herein by reference.

### FIELD

Embodiments described herein relate generally to a display system and glasses.

### BACKGROUND

In recent years, a display device comprising a display panel including a polymer dispersed liquid crystal layer (PDLC), light sources, and the like has been proposed. The polymer dispersed liquid crystal layer can switch a scattering state in which light is scattered and a transparent state in which light is transmitted. The display device can display images in the scattered state. The user can visually recognize a background through the display panel by switching the display panel to the transparent state.

With such a display device, users can visually recognize the displayed image from both sides across the display panel. Depending on the image to be displayed, the image needs to be shown to only one of the users, and the display device is not convenient in this respect.

### BRIEF DESCRIPTION OF THE DRAWINGS

FIG. 1 is a diagram showing a configuration of a display system of a first embodiment.

FIG. 2 is a plan view showing a configuration example of a display panel shown in FIG. 1.

FIG. 3 is a schematic cross-sectional view showing the display panel shown in FIG. 2.

FIG. 4 is an expanded sectional view showing the display panel shown in FIG. 3.

FIG. 5 is a diagram illustrating an example of a path of light emitted by a light source unit.

FIG. 6 is a diagram illustrating an example of a path of light emitted by a light source unit.

FIG. 7 is a schematic side view showing a display system of the first embodiment.

FIG. 8 is a diagram illustrating the display system of the first embodiment.

FIG. 9 is a diagram showing a configuration of a display system of a second embodiment.

FIG. 10 is a diagram showing a configuration of a display system of a third embodiment.

FIG. 11 is a diagram illustrating a configuration example of a retardation element.

FIG. 12 is a diagram illustrating a display system of a third embodiment.

FIG. 13 is a diagram illustrating the display system of the third embodiment.

FIG. 14 is a diagram showing a configuration of a display system of a fourth embodiment.

FIG. 15 is a diagram illustrating a configuration example of a polarizer.

FIG. 16 is a diagram illustrating a display system of a fourth embodiment.

FIG. 17 is a diagram illustrating the display system of the fourth embodiment.

FIG. 18 is a diagram showing a configuration of a display system of a fifth embodiment.

FIG. 19 is a diagram showing a configuration of glasses shown in FIG. 18.

FIG. 20 is a diagram showing a configuration example of glasses provided in a display system of a sixth embodiment.

FIG. 21 is a diagram showing a configuration of a display system of a seventh embodiment.

FIG. 22 is a schematic side view showing a display system of the seventh embodiment.

FIG. 23 is a diagram illustrating the display system of the seventh embodiment.

FIG. 24 is a diagram showing a configuration of a display system of an eighth embodiment.

FIG. 25 is a diagram showing a configuration of a display system of a ninth embodiment.

FIG. 26 is a schematic side view showing a display system of the ninth embodiment.

FIG. 27 is a diagram illustrating the display system of the ninth embodiment.

FIG. 28 is a diagram showing a configuration of a display system of a tenth embodiment.

FIG. 29 is a diagram showing a configuration of a display system of an eleventh embodiment.

FIG. 30 is a diagram showing a configuration of a display system of a twelfth embodiment.

FIG. 31 is a diagram illustrating the display system of the twelfth embodiment.

### DETAILED DESCRIPTION

In general, according to one embodiment, there is provided a display system comprising: a first display panel having a first surface, a second surface on a side opposite to the first surface, and a first display area that is visibly recognizable from the first surface side and the second surface side; and an optical element overlapping with a part of the first display area. The optical element includes at least one of a polarizer absorbing linearly polarized light and a retardation element imparting a ½-wavelength phase difference to transmitted linearly polarized light.

According to another embodiment, there is provided a display system comprising: a display panel having a first surface, a second surface on a side opposite to the first surface, and a first display area that is visibly recognizable from the first surface side and the second surface side; and glasses including a retardation element imparting a ½-wavelength phase difference to transmitted linearly polarized light and a polarizer absorbing linearly polarized light to which the phase difference is imparted.

According to yet another embodiment, there are provided glasses comprising: a retardation element imparting a ½-wavelength phase difference to transmitted linearly polarized light; and a polarizer transmitted through the retardation element to absorb linearly polarized light to which a phase difference is imparted.

According to the configurations, a display system and glasses capable of improving the convenience can be provided.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, and the like of the respective parts are illustrated schematically in the drawings, rather than as an accurate representation of what is implemented, but such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, an X-axis, a Y-axis and a Z-axis orthogonal to each other are described to facilitate understanding as needed. A direction along the X-axis is referred to as a first direction X, a direction along the Y-axis is referred to as a second direction Y, and a direction along the Z-axis is referred to as a third direction Z. Viewing various elements parallel to the third direction Z is referred to as plan view.

The embodiments disclose a display system comprising a highly translucent liquid crystal display device to which polymer dispersed liquid crystal is applied (so-called transparent display) as an example of the display device. However, the configurations disclosed in the embodiments can also be applied to the other types of display devices.

### First Embodiment

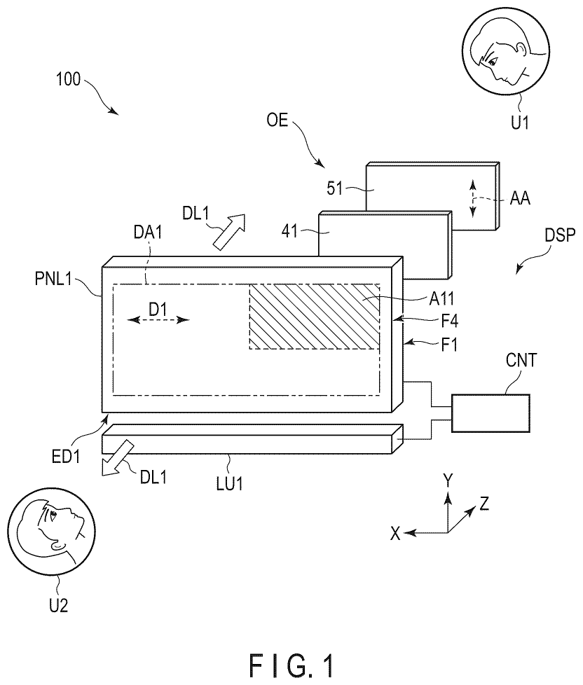

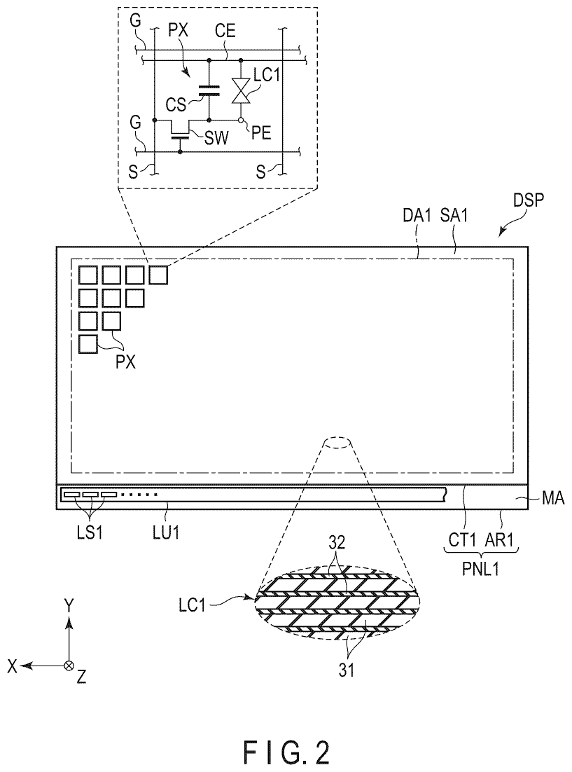

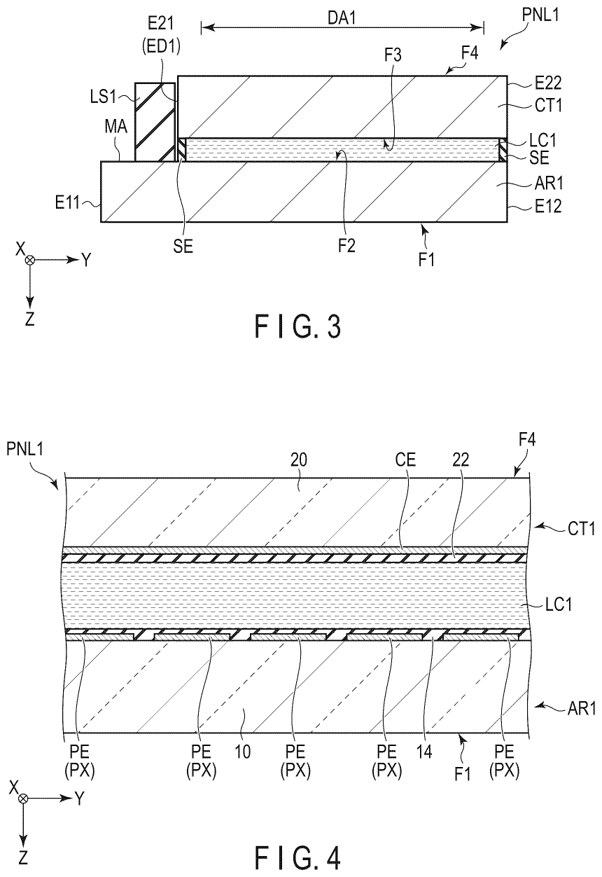

FIG. 1 is a diagram showing a configuration of a display system 100 of the present embodiment. FIG. 2 is a plan view showing a configuration example of a display panel PNL1 shown in FIG. 1. FIG. 3 is a schematic cross-sectional view showing the display panel PNL1 shown in FIG. 2. FIG. 4 is an expanded sectional view showing the display panel PNL1 shown in FIG. 3.

In FIG. 3 and FIG. 4, a structure of the display panel PNL1 is schematically shown. Main portions in the cross-section of the display panel PNL1 parallel to a Y-Z plane defined by the second direction Y and the third direction Z will be described here.

The display system 100 comprises a display device DSP. The display device DSP comprises a display panel PNL1 (first display panel), a light source unit LU1 (first light source unit), an optical element OE, and a controller CNT.

In the example shown in FIG. 1, the display system 100 is located between a user U1 and a user U2. In one example, the user U1 observes the display panel PNL1 in a direction opposite to the third direction Z, and the user U2 observes the display panel PNL1 in the third direction Z.

The display panel PNL1 is formed in a flat plate parallel to the X-Y plane defined by the first direction X and the second direction Y. The display panel PNL1 comprises an array substrate AR1 and a counter-substrate CT1 stacked in the third direction Z, as shown in FIG. 2.

The counter-substrate CT1 is opposed to the array substrate AR1. The shape of each of the array substrate AR1 and the counter-substrate CT1 in plan view is a rectangular shape elongated in the first direction X, in the example shown in FIG. 2. However, the shape of the array substrate AR1 and the counter-substrate CT1 is not limited to this example.

A width of the array substrate AR1 in the second direction Y is larger than a width of the counter-substrate CT1 in the second direction Y. As a result, the array substrate AR1 has a mounting area MA that does not overlap with the counter-substrate CT1. In the mounting area MA, a flexible circuit board or an integrated circuit is mounted, which is not shown in the drawing.

The display panel PNL1 has a display area DA1 (first display area) where images are displayed, and a frame-shaped surrounding area SA1 surrounding the display area DA1 as shown in FIG. 2. Both the display area DA1 and the surrounding area SA1 are formed at a portion where the array substrate AR1 and the counter-substrate CT1 overlap. The display area DA1 includes a plurality of pixels PX arrayed in a matrix in the first direction X and the second direction Y.

The display panel PNL1 further includes a liquid crystal layer LC1 (first liquid crystal layer) sealed between the array substrate AR1 and the counter-substrate CT1. As enlarged and schematically shown on a lower side of FIG. 2, the liquid crystal layer LC1 is composed of polymer dispersed liquid crystal containing polymer 31 and liquid crystal molecules 32.

In one example, the polymer 31 is liquid crystalline polymer. The polymer 31 is formed in a streaky shape extending along the first direction X and is aligned in the second direction Y. The direction of extension of the polymer 31 (first extension direction) is parallel to the first direction X. In FIG. 1, the direction of extension of the polymer 31 is referred to as an extension direction D1. The liquid crystal molecules 32 are dispersed in gaps of the polymer 31 and aligned such that their long axes extend in the first direction X.

The polymer 31 and the liquid crystal molecules 32 have optical anisotropy or refractive anisotropy. The response performance of the polymer 31 to the electric field is lower than the response performance of the liquid crystal molecules 32 to the electric field. In one example, the alignment direction of the polymers 31 is hardly varied irrespective of the presence or absence of the electric field. In contrast, the alignment direction of the liquid crystal molecules 32 is varied in response to the voltage applied to the liquid crystal layer LC1.

In a state in which the voltage is not applied to the liquid crystal layer LC1, optical axes of the respective polymer 31 and liquid crystal molecules 32 are parallel to each other and the light made incident on the liquid crystal layer LC1 is not substantially scattered in the liquid crystal layer LC1 and transmitted (transparent state).

In a state in which the voltage is applied to the liquid crystal layer LC1, the optical axes of the respective polymer 31 and liquid crystal molecules 32 intersect each other and the light made incident on the liquid crystal layer LC1 is scattered in the liquid crystal layer LC1 (scattered state).

The display panel PNL1 is configured to switch the transparent state in which the light emitted from the light source unit LU1 is transmitted in the liquid crystal layer LC1 and the scattered state in which the light emitted from the light source unit LU1 is scattered in the liquid crystal layer LC1.

As expanded on an upper side of FIG. 2, a plurality of scanning lines G and a plurality of signal lines S are arranged in the display area DA1. The plurality of scanning lines G extend in the first direction X and are arranged in the second direction Y. The plurality of signal lines S extend in the second direction Y and are arranged in the first direction X.

Each of the pixels PX comprises a switching element SW, a pixel electrode PE, a common electrode CE, and a capacitance CS. The switching element SW is composed of, for example, a thin-film transistor (TFT) and is electrically connected to the scanning line G and the signal line S. The pixel electrode PE is electrically connected to the switching element SW.

The liquid crystal layer LC (particularly, liquid crystal molecules 32) is driven by an electric field produced between the pixel electrodes PE and the common electrode CE. The capacitance CS is formed between, for example, an electrode having the same electric potential as the common electrode CE and an electrode having the same potential as the pixel electrode PE.

The array substrate AR1 and the counter-substrate CT1 are bonded to each other by a sealing material SE, as shown in FIG. 3. The sealing material SE has a shape that surrounds the display area DA1 in plan view. The liquid crystal layer LC1 is sealed in space surrounded by the sealing material SE.

The array substrate AR1 has a main surface F1 (first surface), a main surface F2 on a side opposite to the main surface F1, and side surfaces E11 and E12 connecting the main surfaces F1 and F2, as shown in FIG. 3. The counter-substrate CT1 has a main surface F3 facing the main surface F2 through the liquid crystal layer LC1, a main surface F4 (second surface) on a side opposite to the main surface F3, and side surfaces E21 and E22 connecting the main surfaces F3 and F4. The main surfaces F1 to F4 are, for example, surfaces parallel to the X-Y plane.

In the display panel PNL1, the main surface F4 corresponds to the surface on the side opposite to the main surface F1. In the example shown in FIG. 1, the main surface F1 corresponds to the surface facing the user U1, and the main surface F4 corresponds to the surface facing the user U2. The display area DA1 can be visually recognized from each of the main surface F1 side and the main surface F4 side.

The side surfaces E11, E12, E21, and E22 extend in the first direction X. In the array substrate AR1, the side surfaces E11 and E12 are aligned in this order in the second direction Y. In the counter-substrate CT1, the side surfaces E21 and E22 are aligned in this order in the second direction Y. The side surface E21 constitutes an end portion ED1 (first end portion) of the display panel PNL1. The side surface E21 extends along the extension direction D1 of the polymer 31.

The array substrate AR1 comprises a transparent substrate 10, a pixel electrode PE, and an alignment film 14, as shown in FIG. 4. The counter-substrate CT1 comprises a transparent substrate 20, a common electrode CE, and an alignment film AL2 as shown in FIG. 4. In the transparent substrate 10, the surface on the side opposite to the liquid crystal layer LC1 corresponds to the main surface F1. In transparent substrate 20, the surface on the side opposite to the liquid crystal layer LC1 corresponds to the main surface F4.

The transparent substrates 10 and 20 are insulating substrates such as glass substrates or plastic substrates. The pixel electrode PE and the common electrode CE are formed of, for example, a transparent conductive material such as indium tin oxide (ITO) or indium zinc oxide (IZO).

The pixel electrodes PE are arranged in the respective pixels PX. The common electrode CE is arranged across a plurality of pixels PX. The alignment films 14 and 22 may be horizontal alignment films having an alignment restriction force approximately parallel to the X-Y plane or vertical alignment films having an alignment restriction force approximately parallel to the third direction Z.

The liquid crystal layer LC1 is located between the alignment films 14 and 22. In one example, the alignment treatment orientation of the alignment films 14 and 22 is parallel to the first direction X, and the alignment films 14 and 22 have the alignment restriction force along the first direction X.

For example, the polymer 31 shown in FIG. 1 is polymerized with the liquid crystalline monomers aligned in the first direction X by the alignment restriction force of the alignment films 14 and 22 and is thereby formed in a streaky shape extending along the first direction X. The liquid crystal layer LC1 is located between the pixel electrodes PE and the common electrode CE.

The light source unit LU1 is arranged along the mounting area MA as shown in FIG. 2. The light source unit LU1 faces the end portion ED1 of the display panel PNL1 as shown in FIG. 1. More specifically, the light source unit LU1 faces the side surface E21. The light source unit LU1 emits light to the end portion ED1.

From the viewpoint of the light source unit LU1, the side surfaces E11 and E21 correspond to the light source unit LU1 side (light incidence side), and the side surfaces E12 and E22 correspond to the side opposite to the light source unit LU1 (opposite incidence side).

The light source unit LU1 comprises a plurality of light sources LS1 arranged in the first direction X in the example shown in FIG. 2. For example, the plurality of light sources LS1 include light emitting elements emitting red light, light emitting elements emitting green light, and light emitting elements emitting blue light. These light emitting elements may be aligned in the first direction X or stacked in the third direction Z. Light emitting diodes (LED) may be used as the light emitting elements.

The controller CNT controls each of the display panel PNL1 and the light source unit LU1. The controller CNT supplies, for example, a first control signal including a first video signal to the display panel PNL1.

The controller CNT supplies a first light source control signal to the light source unit LU1 synchronously with supplying the first control signal to the display panel PNL1. As a result, a display image based on the first video signal is displayed on the display panel PNL1. In this case, the display image is, for example, a letter or character, a photograph, an illustration, a moving image, or the like.

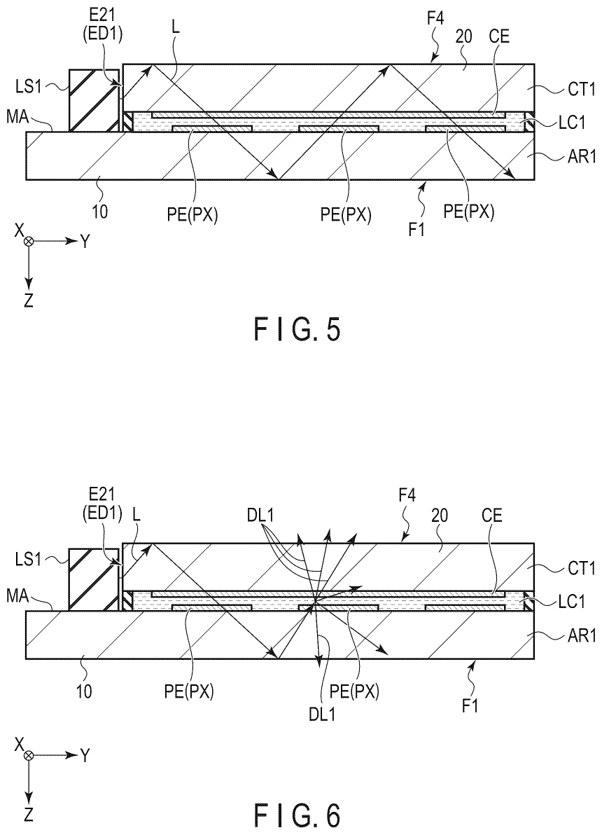

Next, an example of the path of light L emitted by the light source LS1 will be described. FIG. 5 and FIG. 6 are diagrams illustrating an example of the path of light L emitted by light source unit LU1. FIG. 5 shows the transparent state while FIG. 6 shows the scattered state.

Light L emitted from the light source LS1 travels in the second direction Y. The light source LS1 emits light to the end portion ED1 of the display panel PNL1. The light L emitted from the light sources LS1 is made incident on the side surface E21. The light L travels toward the opposite incidence side while repeating total reflection between the main surface F4 and the main surface F1.

As shown in FIG. 5, the light L is hardly scattered by the liquid crystal layer LC1 in the vicinity of the pixel PX (pixel electrode PE) in the transparent state. For this reason, the light L hardly leaks out of the main surfaces F1 and F4.

Incidentally, the external light made incident on the main surfaces F1 and F4 is not substantially scattered and is transmitted through the liquid crystal layer LC1, in the vicinity of the pixel PX in the transparent state. In other words, the background on the main surface F4 side can be visually recognized when the display panel PNL1 is viewed from the main surface F1 side, and the background on the main surface F1 side can be visually recognized when the display panel PNL1 is viewed from the main surface F4 side.

As shown in FIG. 6, the light L is scattered by the liquid crystal layer LC1 in the vicinity of the pixel PX (pixel electrode PE) in the scattered state. The scattered light is emitted from the main surfaces F1 and F4 and is visually recognized as a display image by the users U1 and U2.

In other words, in the scattered state, the display panel PNL1 scatters the light emitted from the light source unit LU1 and emits the light as display light DL1 from the main surfaces F1 and F4. The display light DL1 is linearly polarized light with an oscillation plane parallel to the first direction X. In the present specification, linearly polarized light having an oscillation plane parallel to the first direction X may be referred to as first linearly polarized light, and linearly polarized light having an oscillation plane parallel to the second direction Y may be referred to as second linearly polarized light.

Gradation expression of the degree of scattering (luminance) can also be implemented by defining stepwise the voltage applied to the pixel electrode PE in a predetermined range. As for a system of displaying an image by the display device DSP, for example, a field sequential system of repeating first sub-frames displaying red images by turning on red light emitting elements among the plurality of light sources, second sub-frames displaying green images by turning on green light emitting elements, and third sub-frames displaying blue images by turning on blue light emitting elements can be employed.

The optical element OE includes at least one of a polarizer and a retardation element. In the present embodiment, the optical element OE includes a retardation element 41 and a polarizer 51, as shown in FIG. 1.

The retardation element 41 and the polarizer 51 are formed in as flat plates parallel to the X-Y plane in the example shown in FIG. 1. The size of the retardation element 41 is substantially equal to, for example, the size of the polarizer 51, in plan view. In this case, being substantially equal implies an allowable manufacturing error.

The retardation element 41 imparts a phase difference to the transmitted light (linearly polarized light). More specifically, the retardation element 41 imparts a phase difference of approximately ½ wavelength to the transmitted light (linearly polarized light). In the present embodiment, the retardation element 41 is, for example, a λ/2 plate. λ corresponds to the length of one wavelength.

The polarizer 51 absorbs the linearly polarized light. The polarizer 51 has an absorption axis AA. The absorption axis AA indicates the oscillation direction in the X-Y plane of the light absorbed by the polarizer 51. The absorption axis AA is parallel to the second direction Y in the example shown in FIG. 1. The polarizer 51 thereby absorbs the second linearly polarized light. The absorption axis AA is orthogonal to the extension direction D1 of the polymer 31.

The polarizer 51 has a transmission axis orthogonal to the absorption axis AA in the X-Y plane, which is not shown in the drawing. The transmission axis indicates the oscillation direction in the X-Y plane of light transmitted through the polarizer 51. In the present embodiment, the polarizer 51 is, for example, a polarizing film.

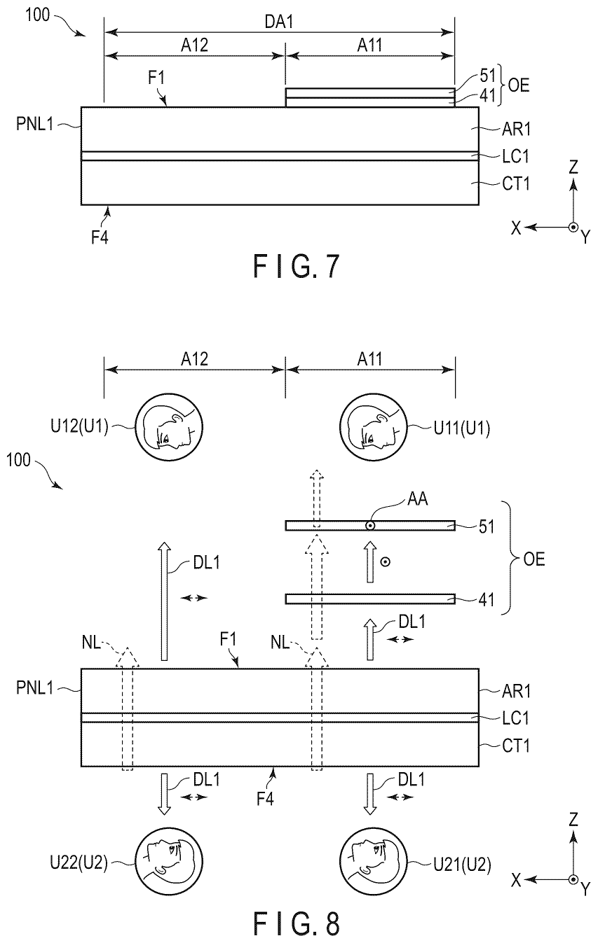

FIG. 7 is a schematic side view showing the display system 100 of the embodiment. In FIG. 7, the display system 100 is viewed in a direction opposite to the second direction Y.

The optical element OE is provided on the array substrate AR1 side in the example shown in FIG. 7. The display panel PNL1, the retardation element 41, and the polarizer 51 are provided in this order in line in the third direction Z. In other words, the phase difference element 41 is provided between the main surface F1 of the display panel PNL1 and the polarizer 51.

In the example shown in FIG. 7, the retardation element 41 is in contact with the main surface F1 of the array substrate AR1 and the polarizer 51. For example, the retardation element 41 is bonded to the main surface F1, and the polarizer 51 is bonded to the retardation element 41. This example indicates a structure in which the optical element OE is bonded to the display panel PNL1, but the optical element OE and the display panel PNL1 may be provided to be separated from each other as shown in, for example, in FIG. 8 to be described below. When the optical element OE and the display panel PNL1 are separated from each other, an air layer is provided between the optical element OE and the display panel PNL1. Furthermore, the retardation element 41 and the polarizing element 51 may be provided to be separated from each other. this case, an air layer is provided between the retardation element 41 and the polarizer 51.

Next, a relationship between the optical element OE and the display area DAI will be described.

The optical element OE overlaps with a part of the display area DA1 in the third direction Z. In other words, the optical element OE does not overlap with the entire display area DA1.

The display area DA1 includes a first area A11 and a second area A12. The first area A11 corresponds to an area of the display area DA1 that overlaps with the optical element OE, and the second area A12 corresponds to an area of the display area DA1 that does not overlap with the optical element OE. In FIG. 1, the first area A11 of the display area DA1 is shown with shaded lines.

The size of the first area A11 is smaller than the size of the display area DA1. In other words, the size of the first area A11 is smaller than the size of the second area A12. For example, the size of the first area A11 is half or less of the size of the display area DA1. The position and size of the first area A11 in the display area DA1 can be set appropriately according to the position and size of the optical element OE.

FIG. 8 is a diagram illustrating the display system 100 of the embodiment.

When the display light DL1 emitted from the main surface F1 is transmitted through the retardation element 41, the oscillation plane of the display light DL1 is rotated at 90 degrees. The display light DL1 emitted from the display panel PNL1 is the first linearly polarized light.

The first linearly polarized light is converted into second circularly polarized light when transmitted through the retardation element 41. The polarizer 51 has an absorption axis AA parallel to the second direction Y. For this reason, most of the light transmitted through the retardation element 41, of the display light DL1 emitted from the main surface F1, is absorbed into the polarizer 51.

A user U11 viewing the first area A11 and a user U12 viewing the second area A12, among the users U1 viewing the display panel PNL1 from the main surface F1 side, are assumed, and a user U21 viewing the first area A11 and a user U22 viewing the second area A12, among the users U2 viewing the display panel PNL1 from the main surface F4 side, are assumed.

The optical element OE is located between the user U11 and the display panel PNL1, and the optical element OE is not located between the user U12 and the display panel PNL1, in the third direction Z.

For this reason, the display light DL1 from the first area A11 is hardly visibly recognized by the user U11, but the display light DL1 from the second area A12 is visibly recognized by the user U12. In other words, the user U11 can hardly visually recognize the display image in the first area A11, but the user U12 can visually recognize the display image in the second area A12. In contrast, the users U21 and U22 viewing the display area DA1 from the main surface F4 side can visually recognize the display images in the first area A11 and the second area A12.

As a result, it is possible to allow the user U2 located on the main surface F4 side to visually recognize the display image and allow the user U1 located on the main surface F1 side not to visually recognize the display image, by displaying the image in the first area A11. The convenience of the display system 100 can be thereby improved. The position and size of the display image which the user U11 can visually recognize can be set as appropriate depending on the position and size of the first area A11.

It is assumed that natural light is transmitted through the display panel PNL1 in the transparent state, in the third direction Z.

In natural light NL transmitted through the first area A11, of the natural light NL transmitted through the display panel PNL1, an oscillation component parallel to the absorption axis AA is absorbed into the polarizer 51. In the natural light NL transmitted through the first area A11, the transmittance of the polarizer 51 is approximately 50%.

In contrast, the natural light NL transmitted through the second area A12 is hardly absorbed into the display panel PNL1. The natural light NL is hardly absorbed either when the natural light is transmitted through the display panel PNL1 in the direction opposite to the third direction Z.

As a result, a higher transparency (transmittance) can be secured in the second area A12 than that in the first area A11. Therefore, in the second area A12, the users U1 and U2 and the background can be visually recognized more easily from the respective sides of the main surfaces F1 and F4 as compared to the first area A11. Therefore, the users U1 and U2 facing each other across the display system 100 can easily communicate with each other.

The convenience can be improved in the display system 100 configured as described above.

In the present embodiment, the example in which the optical element OE is provided on the array substrate AR1 side is disclosed, but the optical element OE may be provided on the counter-substrate CT1 side. In this case, the retardation element 41 is provided on the main surface F4 side of the counter-substrate CT1.

The optical element OE may be provided on each of the array substrate AR1 side and the counter-substrate CT1 side. In this case, the optical element OE provided on the array substrate AR1 side may or may not overlap with the optical element OE provided on the counter-substrate CT1 side in the third direction Z.

In the present embodiment, the example in which the display area DA1 includes one first area A11 is disclosed, but the optical element OE may be provided such that the display area DA1 includes a plurality of first areas A11.

In the present embodiment, the example in which the size of the retardation element 41 is substantially equal to the size of the polarizer 51 is disclosed, but the size of the retardation element 41 may be larger or smaller than the size of the polarizer 51.

The display system 100 may further comprise a light guide. The light guide may use, for example, a lens such as a prism lens. For example, the light guide is provided between the side surface E21 and the plurality of light sources LS1. The display panel PNL1 may further comprise transparent cover members (e.g., cover glasses) that cover the array substrate AR1 and the counter-substrate CT1, respectively.

Next, other embodiments will be described. Differences between the other embodiments described below and the first embodiment will be mainly described. In the other embodiments described below, the same components as those of the above-described first embodiment may be denoted by the same reference numerals as those in the first embodiment, and their detailed description may be omitted or simplified.

### Second Embodiment

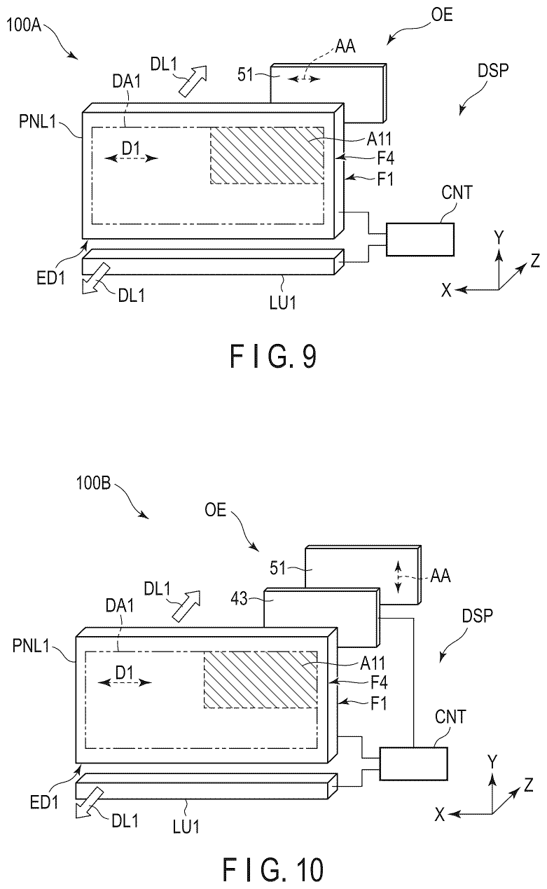

FIG. 9 is a diagram showing a configuration of a display system 100A of the present embodiment. The present embodiment is different from the first embodiment in that the optical element OE does not include a retardation element.

The optical element OE includes a polarizer 51 and does not include a retardation element. The polarizer 51 has an absorption axis AA parallel to the first direction X. In other words, the absorption axis AA is parallel to an extension direction D1 of polymer 31.

The polarizer 51 thereby absorbs first linearly polarized light. In other words, the polarizer 51 absorbs the display light DL1 that is the first linearly polarized light. As a result, the display light DL1 from a first area A11 is hardly visually recognized by a user observing the display area DA1 from a main surface F1 side.

The same advantages as those of the first embodiment can be obtained in the present embodiment. In the present embodiment, the number of components constituting the display system 100A can be reduced, and the manufacturing costs in the display system 100A can be reduced.

### Third Embodiment

FIG. 10 is a diagram showing a configuration of a display system 100B of the present embodiment. The present embodiment is different from the first embodiment in a retardation element.

An optical element OE includes a retardation element 43 and a polarizer 51. The polarizer 51 is, for example, the polarizing film described in the first embodiment. More specifically, the polarizer 51 has an absorption axis AA parallel to the second direction Y. The polarizer 51 thereby absorbs the second linearly polarized light.

The retardation element 43 comprises a function of imparting a phase difference to the light (linearly polarized light) transmitted through itself, a function of varying the phase difference to be imparted, and a function of varying the oscillation plane of the light transmitted through itself in the X-Y plane. Such a retardation element may be referred to as an active retardation element.

The retardation element 43 has a modulation mode and a non-modulation mode. The retardation element 43 imparts a phase difference to the light (linearly polarized light) transmitted through itself in the modulation mode and maintains the oscillation plane of the light (linearly polarized light) transmitted through itself in the non-modulation mode.

The retardation element 43 is controlled by a controller CNT. More specifically, the retardation element 43 is configured to switch the modulation mode and the non-modulation mode by a control signal from the controller CNT.

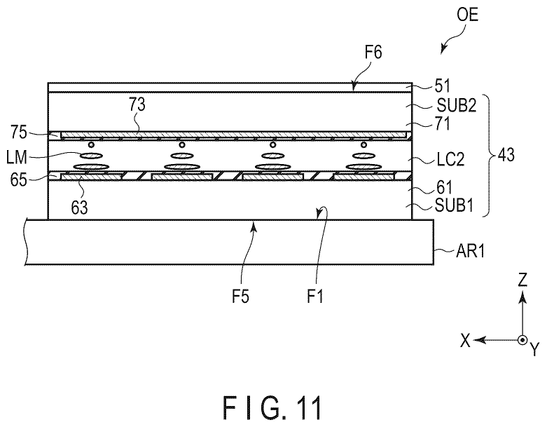

An example of a configuration applicable to the retardation element 43 will be described. FIG. 11 is a diagram illustrating a configuration example of the retardation element 43.

The retardation element 43 is composed of, for example, a liquid crystal element. The retardation element 43 comprises a substrate SUB1, a substrate SUB2, and a liquid crystal layer LC2 held between the substrate SUB1 and the substrate SUB2.

The substrate SUB1 comprises a transparent substrate 61, a plurality of first control electrodes 63, and an alignment film 65. The transparent substrate 61 has a main surface F5 on a side opposite to the liquid crystal layer LC2. The main surface F5 faces the main surface F1 of the display panel PNL1. The main surface F5 is, for example, in contact with the main surface F1 of the display panel PNL1. The main surface F5 may be provided to be spaced apart from the main surface F1 of the display panel PNL1.

The second substrate SUB2 comprises a transparent substrate 71, a second control electrode 73, and an alignment film 75. The transparent substrate 71 has a main surface F6 on a side opposite to the liquid crystal layer LC2. The main surface F6 faces the polarizer 51. The main surface F6 is, for example, in contact with the polarizer 51. The main surface F6 may be provided to be spaced apart from the polarizer 51.

The second control electrode 73 faces a plurality of first control electrodes 63 through the liquid crystal layer LC2. The first control electrodes 63 and the second control electrode 73 are formed of a transparent conductive material such as ITO or IZO.

The first control electrode 63 and the second control electrode 73 apply voltages to the liquid crystal layer LC2 under control of the controller CNT. The alignment films 65 and 75 are, for example, horizontal alignment films. In one example, the alignment treatment direction of the alignment film 65 is parallel to the first direction X, and the alignment treatment direction of the alignment film 75 is parallel to the second direction Y.

The liquid crystal layer LC2 is formed of, for example, a liquid crystal material having positive dielectric anisotropy. The liquid crystal molecules LM in the liquid crystal layer LC2 are oriented in a 90° twist orientation when no voltage is applied.

In other words, the liquid crystal molecules LM near the first control electrode 63 are initially aligned such that their major axes are aligned in the first direction X, and the liquid crystal molecules LM near the second control electrode 73 are initially aligned such that their major axes are aligned in the second direction Y.

The liquid crystal molecules LM are aligned such that their long axes extend along the electric field in a state in which a voltage is formed. For example, the state in which no voltage is applied to the liquid crystal layer LC2 corresponds to the modulation mode, and the state in which the voltage is applied to the liquid crystal layer LC2 corresponds to the non-modulation mode.

The retardation element 43 can control a phase difference in one pixel unit of the display panel PNL1. Incidentally, the retardation element 43 needs only to comprise a function to impart or not to impart a predetermined phase difference to the light transmitted through itself, and is not limited to the configuration described above.

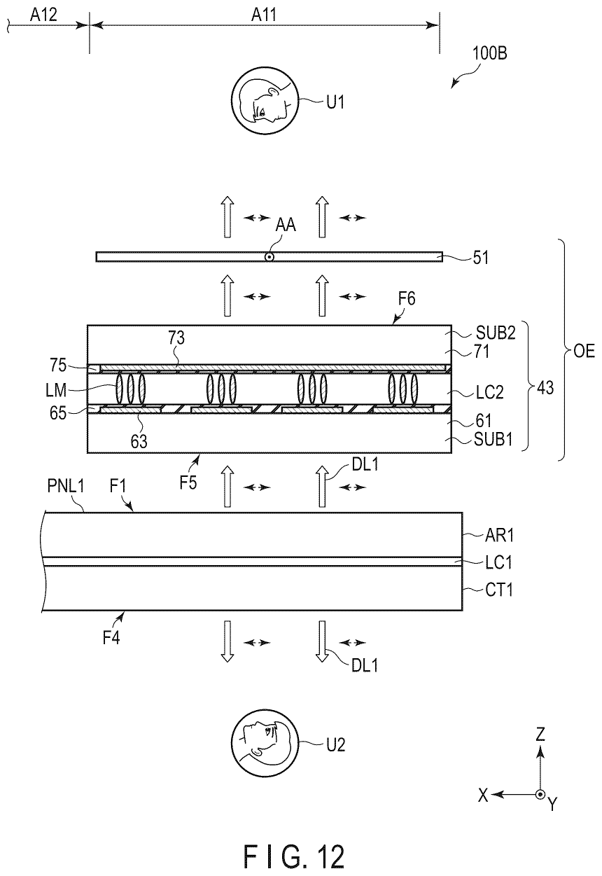

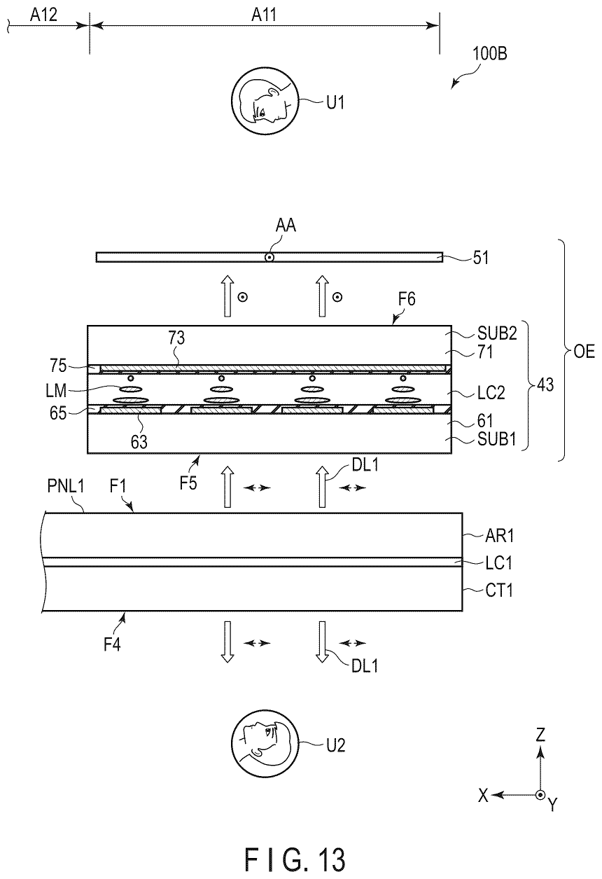

FIG. 12 and FIG. 13 are diagrams illustrating the display system 100B of the present embodiment.

FIG. 12 shows the state in which the voltage is applied to the liquid crystal layer LC2 (non-modulation mode). In this case, since an electric field along the third direction Z is formed in an area in which the first control electrodes 63 faces the second control electrode 73, the liquid crystal molecules LM are vertically aligned such that their long axes extend along the third direction Z.

FIG. 13 shows the state in which no voltage is applied to the liquid crystal layer LC2 (modulation mode). In this case, since no electric field is formed in the area where the first control electrode 63 faces the second control electrode 73, the liquid crystal molecules LM are maintained in the initial orientation state and are twist-oriented.

The display light DL1 emitted from the main surface F1 of the display panel PNL1 is first linearly polarized light. The display light DL1 from the main surface F1 is made incident on the retardation element 43.

In FIG. 12, the first linearly polarized light made incident from the main surface F5 of the retardation element 43 is hardly affected by the vertically oriented liquid crystal molecules LM, with its oscillation plane maintained, and is transmitted through the liquid crystal layer LC2. The display light DL1 transmitted through the retardation element 43 is transmitted through the polarizer 51. The retardation element 43 does not impart a phase difference to the transmitted light (linearly polarized light) in the non-modulation mode.

In FIG. 13, the first linearly polarized light made incident from the main surface F1 of the retardation element 43 is affected by the twist-oriented liquid crystal molecules LM, with its oscillation plane rotated, and is transmitted through the liquid crystal layer LC2 and then converted into the second linearly polarized light.

In other words, the retardation element 43 imparts a phase difference of approximately λ/2 to the transmitted light in the modulation mode. Most of the display light DL1 transmitted through the retardation element 43 is absorbed into the polarizer 51.

Therefore, the user U1 can visually recognize the display image in the first area A11 when the retardation element 43 is in the non-modulation mode, and can hardly visually recognize the display image in the first area A11 when the retardation element 43 is in the modulation mode. The user U2 located on the main surface F4 side can visually recognize the display image in the first area A11 in the modulation mode and the non-modulation mode.

In the first area A11, the display light DL1 is visibly recognized by the only user U2 and not by the user U1 in the modulation mode, but is visibly recognized by both the users U1 and U2 in the no-modulation mode.

The same advantages as those of the first embodiment can be obtained in the present embodiment. The retardation element 43 in the present embodiment can switch the modulation mode and the non-modulation mode. As a result, according to the display system 100B of the present embodiment, it is possible to switch whether the display image in the first area A11 among the display images of the display area DA1 is shared by both the users U1 and U2 or visibly recognized by the only user U2. The convenience of the display system 100B can be thereby further improved.

### Fourth Embodiment

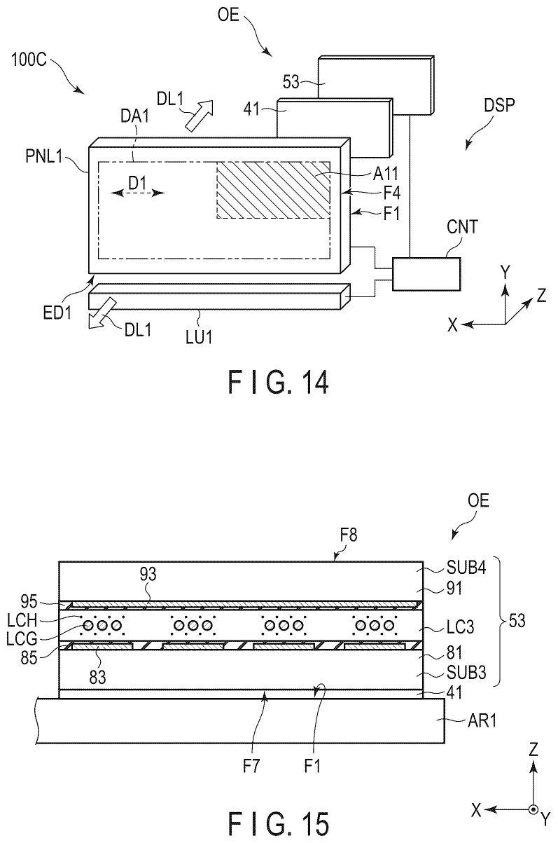

FIG. 14 is a diagram showing a configuration of a display system 100C of the embodiment. The present embodiment is different from the first embodiment in a polarizer. An optical element OE includes a retardation element 41 and a polarizer 53. The retardation element 41 is, for example, a λ/2 plate described in the first embodiment.

The polarizer 53 comprises a function of varying the transmittance of light transmitted through itself (dimming function). Such a polarizer may be referred to as an active polarizer. The polarizer 53 has an absorption mode and a transmission mode.

The polarizer 53 absorbs linearly polarized light in the absorption mode and transmits linearly polarized light in the transmission mode. The polarizer 53 is controlled by a controller CNT. More specifically, the polarizer 53 is configured to switch the absorption mode and the transmission mode by a control signal from the controller CNT.

For example, an electrochemical reaction element such as a guest-host liquid crystal element, a suspended particle device (SPD), an electrochromic element or an electrodeposition element, or the like is desirable as the polarizer 53.

An example in which the polarizer 53 is composed of a guest-host liquid crystal device, as an example of a configuration applicable to the polarizer 53, will be described. FIG. 15 is a diagram illustrating a configuration example of the polarizer 53.

The retardation element 53 comprises a substrate SUB3, a substrate SUB4, and a liquid crystal layer LC3 held between the substrate SUB3 and the substrate SUB4. The substrate SUB3 comprises a transparent substrate 81, a plurality of third control electrodes 83, and an alignment film 85. The transparent substrate 81 has a main surface F7 on a side opposite to the liquid crystal layer LC3. The main surface F7 faces the retardation element 41. The main surface F7 is, for example, in contact with the retardation element 41. The main surface F7 may be provided to be spaced apart from the retardation element 41.

The substrate SUB4 comprises a transparent substrate 91, a fourth control electrode 93, and an alignment film 95. The transparent substrate 91 has a main surface F8 on a side opposite to the liquid crystal layer LC3.

The fourth control electrode 93 faces a plurality of third control electrodes 83 through the liquid crystal layer LC3. The third control electrodes 83 and the fourth control electrode 93 are formed of a transparent conductive material such as ITO or IZO.

The third control electrode 83 and the fourth control electrode 93 apply voltages to the liquid crystal layer LC3 under control of the controller CNT. The alignment films 85 and 95 are, for example, horizontal alignment films. In one example, the alignment treatment direction of each of the alignment films 85 and 95 is parallel to the second direction Y.

The liquid crystal layer LC3 is a guest-host liquid crystal layer. The liquid crystal layer LC3 includes dyes (for example, dichroic dyes) LCG having anisotropy in the visible light absorbency (absorptivity) as guest molecules, and liquid crystal molecules LCH of a nematic liquid crystal as host molecules.

The dyes have absorbency of more strongly absorbing a polarization component which oscillates in a long-axis direction of a molecule as compared to a polarization component which oscillates in a short-axis direction of the molecule. In the liquid crystal layer LC3, the dye LCG can be aligned in a desired direction in association with the alignment of the liquid crystal molecules LCH.

In one example, the liquid crystal layer LC3 is formed of a liquid crystal material having positive dielectric anisotropy. The liquid crystal molecules LCH contained in the liquid crystal layer LC3 are initially aligned along the second direction Y by the alignment restriction force of each of the alignment films 85 and 95 when no voltage is applied.

The dye LCG is initially aligned along the second direction Y in association with the alignment of the liquid crystal molecules LCH. The liquid crystal molecules LCH are aligned such that their long axes extend along the electric field when a voltage is formed, and the dye LCG is similarly aligned such that its long axis is parallel to the long axes of the liquid crystal molecules LCH.

For example, the state in which no voltage is applied to the liquid crystal layer LC3 corresponds to the absorption mode, and the state in which the voltage is applied to the liquid crystal layer LC3 corresponds to the transmission mode. The polarizer 53 can control the transmittance in one pixel unit of the display panel PNL1.

Incidentally, the liquid crystal layer LC3 may be formed of a liquid crystal material having negative dielectric constant anisotropy, and the alignment films 85 and 95 may be vertically aligned films. In such a configuration example, the state in which no voltage is applied to the liquid crystal layer LC3 corresponds to the transmission mode, and the state in which the voltage is applied to the liquid crystal layer LC3 corresponds to the absorption mode.

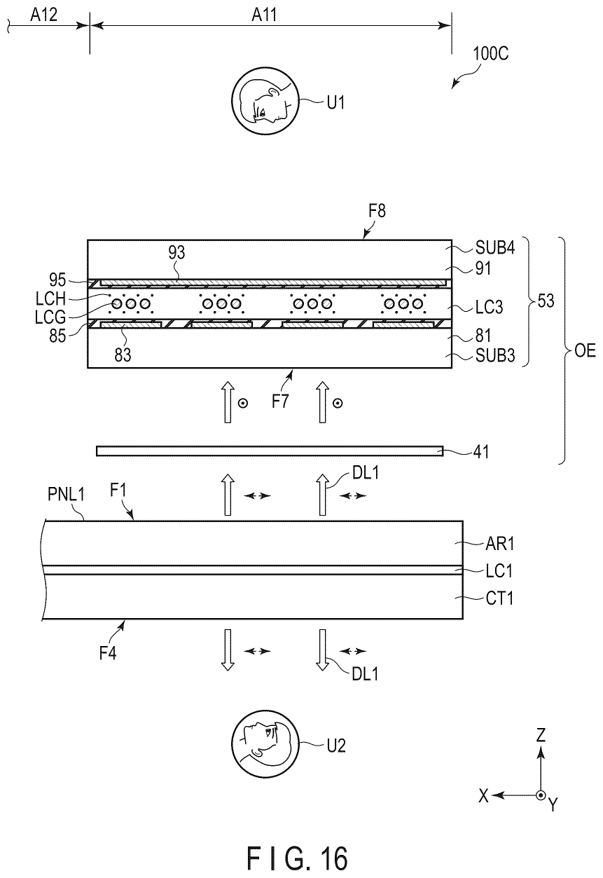

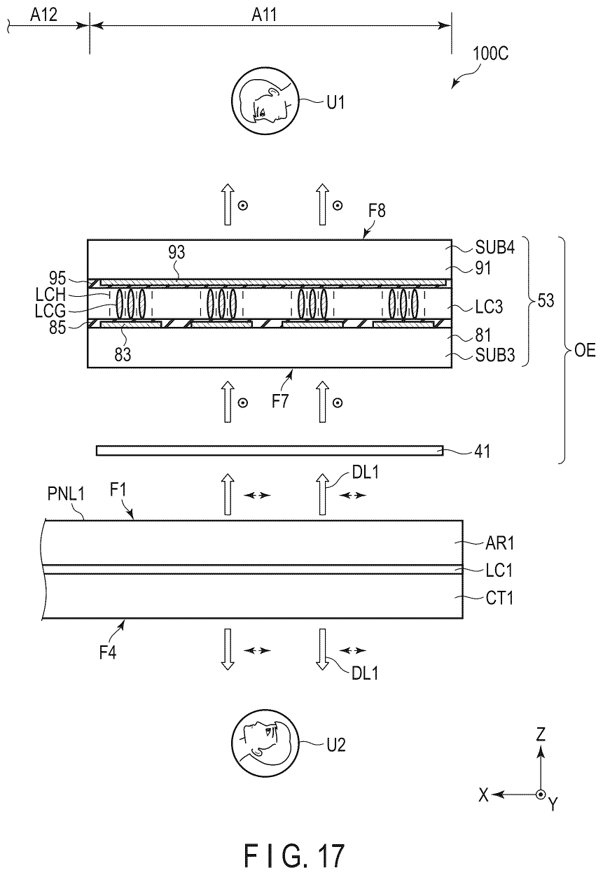

FIG. 16 and FIG. 17 are diagrams illustrating the display system 100C of the present embodiment.

FIG. 16 shows the state in which no voltage is applied to the liquid crystal layer LC3 (absorption mode). In this case, since no electric field is formed in the area where the third control electrode 83 faces the fourth control electrode 93, the liquid crystal molecules LCH and the dye LCG are maintained in their initial alignment state and are horizontally aligned along the second direction Y.

FIG. 17 shows the state in which the voltage is applied to the liquid crystal layer LC3 (transmission mode). In this case, since an electric field along the third direction Z is formed in the area in which the third control electrode 83 faces the fourth control electrode 93, in the polarizer 53, the liquid crystal molecules LM and the dye LCG are vertically aligned such that their long axes extend along the third direction Z.

The display light DL1 emitted from the main surface F1 of the display panel PNL1 is first linearly polarized light. The display light DL1 from the main surface F1 is transmitted through the retardation element 41, and is converted into second circularly polarized light.

In FIG. 16, the second linearly polarized light made incident from the main surface F7 of the polarizer 53 has its oscillation surface parallel to the long axis of the horizontally aligned dye LCG. For this reason, the second linearly polarized light is absorbed by the dye LCG.

In FIG. 17, the second linearly polarized light made incident from the main surface F7 of the polarizer 53 has its oscillation plane intersecting or orthogonal to the long axis of the vertically aligned dye LCG. For this reason, the second linearly polarized light is hardly absorbed into the dye LCG and transmitted through the polarizer 53.

Therefore, the user U1 can visually recognize the display image in the first area A11 when the polarizer 53 is in the transmission mode, and can hardly visually recognize the display image in the first area A11 when the polarizer 53 is in the absorption mode. The user U2 located on the main surface F4 side can visually recognize the display image in the first area A11 in the transmission mode and the absorption mode.

In the first area A11, the display light DL1 is visibly recognized by the only user U2 and not by the user U1 in the absorption mode, but is visibly recognized by both the users U1 and U2 in the transmission mode.

The same advantages as those of the first embodiment can be obtained in the present embodiment. The polarizer 53 in the present embodiment can switch the absorption mode and the transmission mode. As a result, according to the display system 100C of the present embodiment, it is possible to switch whether the display image in the first area A11 among the display images of the display area DA1 is shared by both the users U1 and U2 or visibly recognized by the only user U2. The convenience of the display system 100C can be thereby further improved.

Incidentally, the polarizer 53 in the present embodiment may be applied to the display system 100B of the second embodiment.

### Fifth Embodiment

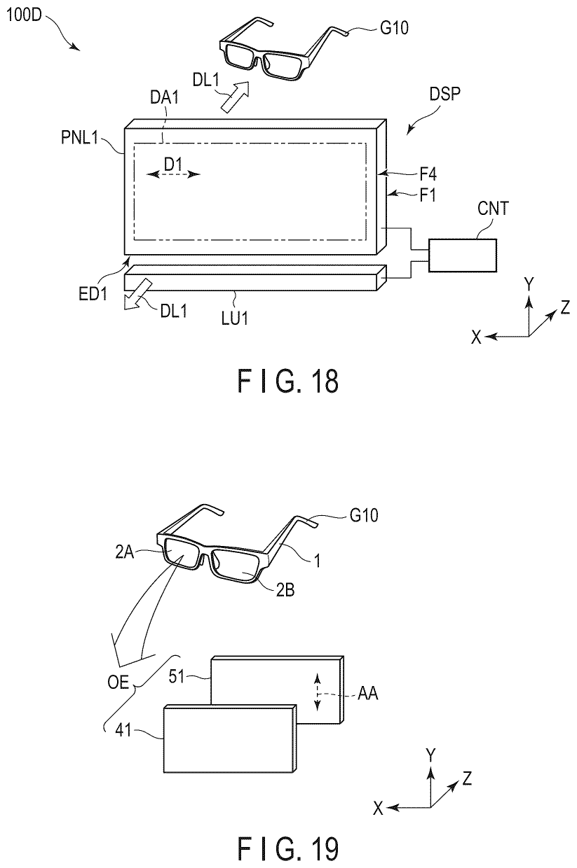

FIG. 18 is a diagram showing a configuration of a display system 100D of the present embodiment. FIG. 19 is a diagram showing a configuration example of glasses shown in FIG. 18. The present embodiment is different from the first embodiment in that a display system 100D comprises glasses G10.

The display system 100D comprises a display device DSP and the glasses G10. The glasses G10 are an example of an attachment (accessory) to be used together with the display device DSP. As shown in FIG. 19, the glasses G10 comprise a frame 1 and lens members 2A and 2B provided on the frame 1.

The lens members 2A and 2B face the user's eyes when the user uses the glasses G10. The lens member 2B is configured in the same manner as the lens member 2A. The lens member 2A will be described.

The lens member 2A includes an optical element OE. The optical element OE includes a retardation element 41 and a polarizer 51. The retardation element 41 and the polarizer 51 are stacked in this order in a direction toward the user.

The retardation element 41 and the polarizer 51 are, for example, a λ/2 plate and a polarizing film described in the first embodiment. More specifically, the polarizer 51 has an absorption axis AA parallel to the second direction Y. The polarizer 51 thereby absorbs the second linearly polarized light.

It is assumed that the user using the glasses G10 observes the main surface F1 of the display panel PNL1 in a direction opposite to the third direction Z. In this case, the glasses G10 are separated from the display panel PNL1.

An extension direction D1 of the polymer 31 is parallel to the first direction X. Therefore, the display light DL1 of the display panel PNL1 is the first linearly polarized light. The display light DL1 emitted from the main surface F1 is converted into second linearly polarized light when transmitted through the retardation element 41 of the glasses G10.

The polarizer 51 has an absorption axis AA parallel to the second direction Y. For this reason, most of the light transmitted through the retardation element 41 of the glasses G10, of the display light DL1 emitted from the main surface F1, is absorbed into the polarizer 51.

The display light DL1 from the display area DA1 is hardly visibly recognized by the user using the glasses G10. In other words, when the user uses the glasses G10, the user can hardly visibly recognize the display image in the display area DA1. This situation is the same as the case where the user observing the display panel PNL1 from the main surface F4 side uses the glasses G10. In contrast, the user who does not use the glasses G10 can visually recognize the display image of the display area DA1.

It is possible to allow the user to visibly recognize or not to visibly recognize the display image in the display area DA1, depending on whether or not the user uses the glasses G10.

The convenience can be improved in the display system 100D configured as described above. It is possible to control a plurality of users visually recognizing the display image, by allowing a plurality of users to use the glasses G10.

In the present embodiment, the display device DSP does not comprise the optical element OE. For this reason, natural light NL transmitted through the display panel PNL1 is hardly absorbed. Therefore, since the high transparency of the display panel PNL1 can be ensured, the user can easily be visually recognized from the side of each of the main surfaces F1 and F4 when the glasses G10 are not used.

Incidentally, in the present embodiment, the example in which the glasses G10 include the retardation element 41 and the polarizer 51 is disclosed, but the glasses G10 may include the polarizer 51, and the display device DSP may include the retardation element 41. For example, the retardation element 41 may overlap with the entire display area DA1 or a part of the display area DA1.

In another example, in the display system 100D, the glasses G10 may include the only polarizer 51, and the glasses G10 and the display device DSP may not include the retardation element 41. In this case, the absorption axis AA of the polarizer 51 is desirably parallel to the extension direction D1 of the polymer 31. For example, when the extension direction D1 of the polymer 31 is parallel to the first direction X, the absorption axis AA of the polarizer 51 is parallel to the first direction X.

### Sixth Embodiment

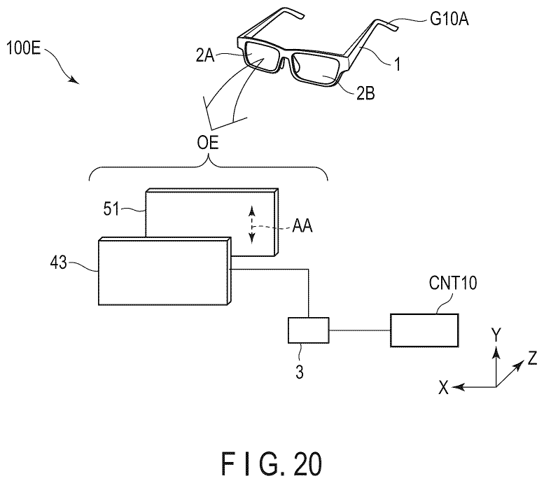

FIG. 20 is a diagram showing a configuration example of glasses G10A provided in a display system 100E of the embodiment. The present embodiment is different from the fifth embodiment in a retardation element.

For example, the retardation element 43 is configured in the same manner as the retardation element described in the third embodiment. More specifically, the retardation element 43 is configured to switch the modulation mode and the non-modulation mode.

The glasses G10A further comprise a control unit 3 as shown in FIG. 20. For example, the control unit 3 is provided at any portion of the frame 1. The control unit 3 is electrically connected to the retardation element 43.

The display system 100E may further comprise a controller CNT10. The control unit 3 is communicatively connected to the controller CNT10. The control unit 3 may be connected to the controller CNT10 by a wired or wireless manner.

In one example, the controller CNT10 is a remote controller. The controller CNT10 can switch the modulation mode and the non-modulation mode. More specifically, the control unit 3 switches the modulation mode and the non-modulation mode, based on the control signal output from the controller CNT10.

The same advantages as those of the fifth embodiment can be obtained in the present embodiment. The retardation element 43 in the present embodiment can switch the modulation mode and the non-modulation mode. If the user with the controller CNT10 operates the glasses G10A in the present embodiment, it is possible to allow the user using the glasses G10A to visually recognize or not to visually recognize the display image.

The convenience of the display system 100E can be thereby improved. Incidentally, the polarizer 53 in the fourth embodiment may be applied to the polarizer 51 in each of the fifth embodiment and the present embodiment.

In this case, the control unit 3 may control the polarizer 53. More specifically, the control unit 3 may switch the modulation mode and the non-modulation mode, based on the control signal output from the controller CNT10.

### Seventh Embodiment

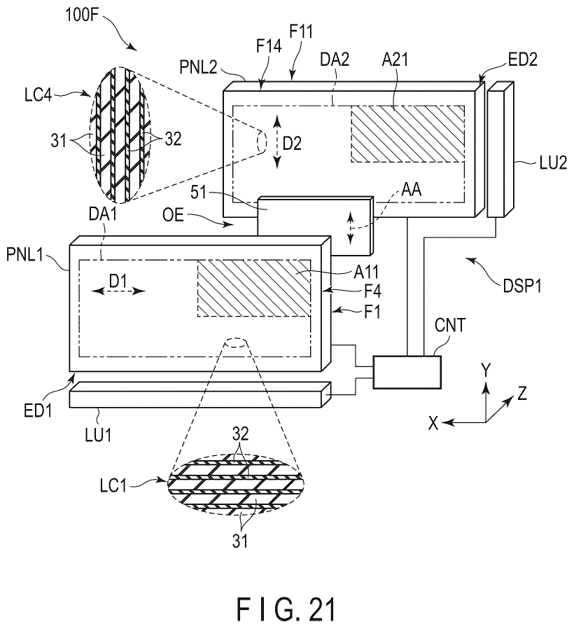

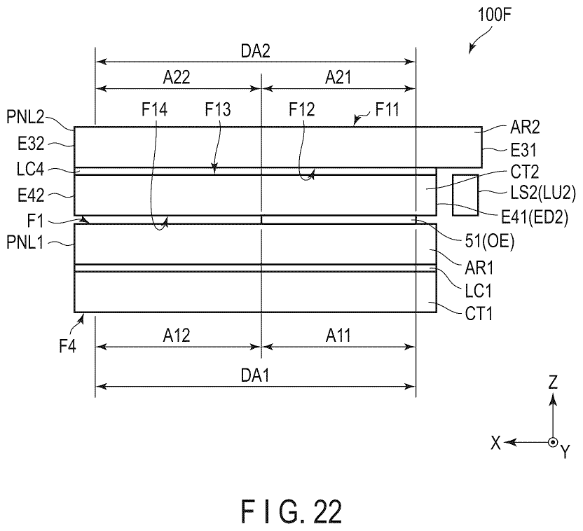

FIG. 21 is a diagram showing a configuration of a display system 100F of the embodiment. FIG. 22 is a schematic side view showing the display system 100F of the present embodiment. The present embodiment is different from each of the above-described embodiments in that a display system 100F comprises a plurality of display panels.

The display system 100F comprises a display device DSP1. The display system DSP1 comprises a display panel PNL1 (first display panel), a display panel PNL2 (second display panel), a light source unit LU1 (first light source unit), a light source unit LU2 (second light source unit), an optical element OF, and a controller CNT.

The display panel PNL2 is formed in a flat plate shape parallel to the X-Y plane. The display panel PNL2 faces the display panel PNL1. The optical element OE is located between the display panel PNL1 and the display panel PNL2.

The display panel PNL2 is configured similarly to the display panel PNL1, and the light source unit LU2 is configured similarly to the light source unit LU1. The display panel PNL2 comprises an array substrate AR2 and a counter-substrate CT2 stacked in the third direction Z, as shown in FIG. 22.

The display panel PNL2 has a display area DA2 (second display area) where images are displayed. The display area DA2 overlaps with the first display area DA1 in the third direction Z. For example, the size of the display area DA2 is substantially equal to the size of the display area DA1.

The display panel PNL2 further has a liquid crystal layer LC4 (second liquid crystal layer) sealed between the array substrate AR2 and the counter-substrate CT2. The liquid crystal layer LC4 is configured by polymer dispersed liquid crystal containing polymer 31 and liquid crystal molecules 32.

The polymer 31 of the liquid crystal layer LC4 is formed in a streaky shape extending along the second direction Y and is aligned in the first direction X. The extension direction of the polymer 31 of the liquid crystal layer LC4 (second extension direction) is parallel to the second direction Y.

In FIG. 21, the extension direction of the polymer 31 of the liquid crystal layer LC4 is shown as an extension direction D2. The liquid crystal molecules 32 of the liquid crystal layer LC4 are dispersed in gaps of the polymer 31 and aligned such that their long axes extend along the second direction Y. The extension direction D2 of the polymer of the liquid crystal layer LC4 is orthogonal to the extension direction D1 of the polymer of the liquid crystal layer LC1.

Similarly to the display panel PNL1, the display panel PNL2 is configured to switch the transparent state and the scattered state by the controller CNT.

The array substrate AR2 has a main surface F11 (fourth surface), a main surface F12 on a side opposite to the main surface F11, and side surfaces E31 and E32 connecting the main surfaces F11 and F12, as shown in FIG. 22. The counter-substrate CT2 has a main surface F13 facing the main surface F12 through the liquid crystal layer LC4, a main surface F14 (third surface) on a side opposite to the main surface F13, and side surfaces E41 and E42 connecting the main surfaces F13 and F14. The main surfaces F11 to F14 are, for example, surfaces parallel to the X-Y plane.

In the display panel PNL2, the main surface F11 corresponds to the surface on the side opposite to the main surface F14. The main surface F14 corresponds to the surface facing the main surface F1 of the display panel PNL1, and the main surface F11 corresponds to the surface facing the user U1. The display area DA2 can be visually recognized from each of the main surface F11 side and the main surface F14 side.

Side surfaces E31, E32, E41, and E42 extend in the second direction Y. In the array substrate AR2, the side surfaces E31 and E32 are aligned in this order in the first direction X. In the counter-substrate CT2, the side surfaces E41 and E42 are aligned in this order in the second direction Y. The side surface E41 constitutes an end portion ED2 (second end portion) of the display panel PNL2. The side surface E41 extends along the extension direction D2 of the polymer 31 of the liquid crystal layer LC2.

The light source unit LU2 irradiates light to the end portion ED2. The light source unit LU2 faces the end portion ED2 of the display panel PNL2 as shown in FIG. 21. More specifically, the light source unit LU2 faces the side surface E41 as shown in FIG. 22.

From the viewpoint of the light source unit LU2, the side surfaces E31 and E41 correspond to the light source unit LU2 side (light incidence side), and the side surfaces E32 and E42 correspond to the side opposite to the light source unit LU2 (opposite incidence side). The second light source unit LU2 comprises a plurality of light sources LS2 arranged in the second direction Y.

The controller CNT controls each of the display panels PNL1 and PNL2 and the light source units LU1 and LU2. The controller CNT supplies, for example, a second control signal including a second video signal to the display panel PNL2. The controller CNT supplies a second light source control signal to the light source unit LU2 synchronously with supplying the second control signal to the display panel PNL2. As a result, a display image based on the second video signal is displayed on the display panel PNL2.

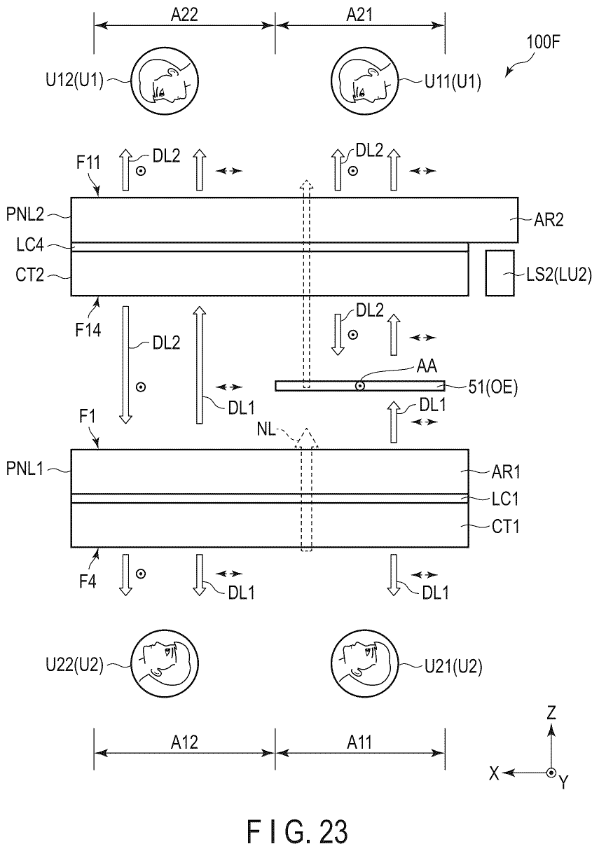

In the scattered state, the display panel PNL2 scatters the light emitted from the light source unit LU2 and emits the light as display light DL2 (shown in FIG. 23) from the main surfaces F11 and F14. The display light DL2 is linearly polarized light with an oscillation plane parallel to the second direction Y.

In the present embodiment, the optical element OE includes a polarizer 51 and does not include a retardation element. The display panel PNL1, the polarizer 51, and the display panel PNL2 are provided to be aligned in this order in the third direction Z.

The polarizer 51 faces each of the main surface F1 of the display panel PNL1 and the main surface F14 of the display panel PNL2 as shown in FIG. 22. In other words, the polarizer 51 is provided between the display panel PNL1 and the display panel PNL2. The polarizer 51 may have a structure of being bonded to the display panel PNL1 and the display panel PNL2 or a structure of being provided to be separated from each of the display panel PNL1 and the display panel PNL2 via an air layer.

In contrast, a gap is formed between the display panel PNL1 and the display panel PNL2, in the area where the optical element OE is not provided, but a transparent layer (not shown) may be formed in the gap. The transparent layer may be, for example, a layer having a refractive index substantially equal to that of the transparent substrates 10 and 20 (shown in FIG. 4) or may be an air layer.

The polarizer 51 has an absorption axis AA parallel to the second direction Y. The polarizer 51 thereby absorbs the second linearly polarized light. The polarizer 51 is, for example, the polarizing film described in the first embodiment.

The optical element OE overlaps with parts of the display areas DA1 and DA2 in the third direction Z. The display area DA1 includes a first area A11 and a second area A12. The display area DA2 includes a first area A21 and a second area A22.

The first areas A11 and A21 are the areas overlapping with the optical element OE, and the second areas A12 and A22 are the areas not overlapping with the optical element OE. In FIG. 21, the first areas A11 and A21 are shown with shaded lines. The size of the first area A11 is substantially equal to the size of the first area A21.

The size of the first areas A11 and A21 is smaller than the size of the display areas DA1 and DA2. The size of the first areas A11 and A21 is half or less of the size of the display areas DA1 and DA2. The position and size of the first areas A11 and A21 in the display areas DA1 and DA2 can be set appropriately according to the position and size of the optical element OE.

FIG. 23 is a diagram illustrating the display system 100F of the embodiment.

The user U11 viewing the first area A21 from the main surface F11 side and the user U21 viewing the first area A11 from the main surface F4 side are assumed.

The display light DL1 emitted from the display panel PNL1 is the first linearly polarized light. The display light DL1 emitted from the main surface F1 is transmitted through the polarizer 51 and further transmitted through the display panel PNL2.

The display light DL2 emitted from the display panel PNL2 is the second linearly polarized light. The display light DL2 emitted from the main surface F14 is absorbed into the polarizer 51 and is not transmitted through the display panel PNL1.

For this reason, the display light DL2 from the display panel PNL2 is hardly visibly recognized by the user U21, but the display light DL1 from the display panel PNL1 is visibly recognized by the user U11. In other words, the user U21 can hardly visibly recognize the display image of the display panel PNL2.

Next, the user U12 viewing the second area A22 from the main surface F11 side and the user U22 viewing the second area A12 from the main surface F4 side are assumed.

The display light DL2 emitted from the main surface F14 is transmitted through the display panel PNL1, and the display light DL1 emitted from the main surface F1 is transmitted through the display panel PNL2. For this reason, the display light DL1 and DL2 from the display panels PNL1 and PNL2 is visibly recognized by both the users U1 and U2.

In the display panel PNL1, the display image of the display panel PNL2 is hardly displayed in the first area A11. Therefore, the user U21 can visibly recognize the display image of the display panel PNL1 while hardly visibly recognizing a mirror image (laterally reversed image) of the display image of the display panel PNL2, and the visibility can be improved.

It is assumed that natural light is transmitted through the display panels PNL1 and PNL2 in the transparent state, in the third direction Z.

Natural light NL transmitted through the first area A11, of the natural light NL transmitted through the display panel PNL1, has an oscillation component parallel to the absorption axis AA absorbed into the polarizer 51, and is transmitted through the display panel PNL2. In the natural light NL transmitted through the first area A11, the transmittance of the polarizer 51 is approximately 50%. In contrast, the natural light NL transmitted through the second area A12 is hardly absorbed into the display panels PNL1 and PNL2.

As a result, a high transparency can be secured in the second area A12 as compared to that in the first area A11. The same advantage can also be obtained when the natural light NL is transmitted through the display panels PNL1 and PNL2 in the direction opposite to the third direction Z.

Therefore, in the second areas A12 and A22, the user and the background can easily be visibly recognized from the respective sides of the main surfaces F4 and F11 as compared to the first areas A11 and A21. As a result, the users facing each other across the display system 100F can easily communicate with each other. The convenience can be improved in the display system 100F configured as described above.

In the present embodiment, the example in which the polarizer 51 is configured to absorb the display light DL2 of the display panel PNL2 is disclosed, but the polarizer 51 may be configured to absorb the display light DL1 of the display panel PNL1. More specifically, the polarizer 51 may have an absorption axis AA parallel to the first direction X.

In the present embodiment, the example in which the array substrate AR1 of the display panel PNL1 faces the counter-substrate CT2 of the display panel PNL2 is disclosed, but the array substrate AR1 of the display panel PNL1 may be configured to face the array substrate AR2 of the display panel PNL2.

### Eighth Embodiment

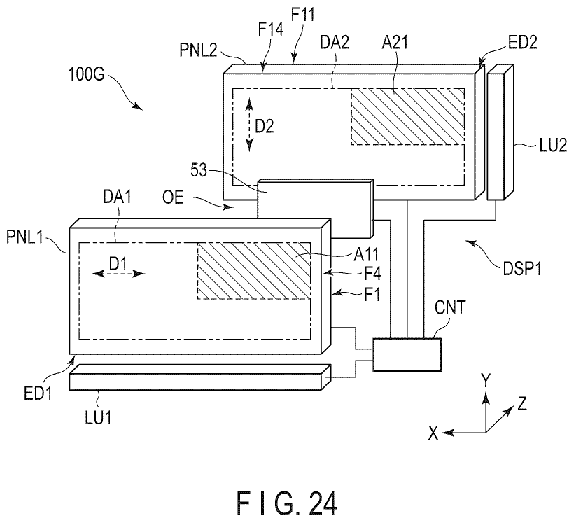

FIG. 24 is a diagram showing a configuration of a display system 100G of the present embodiment. The present embodiment is different from the seventh embodiment in a polarizer.

An optical element OE comprises a polarizer 53. For example, the polarizer is configured in the same manner as the polarizer described in the fourth embodiment. More specifically, the polarizer 53 is configured to switch the absorption mode and the transmission mode by a control signal from the controller CNT.

The same advantages as those of the seventh embodiment can be obtained in the present embodiment.

### Ninth Embodiment

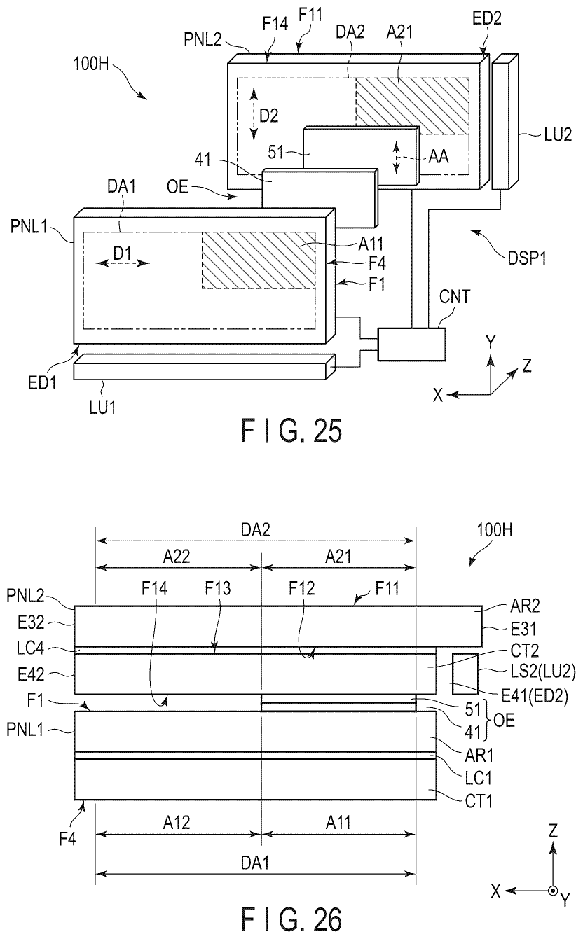

FIG. 25 is a diagram showing a configuration of a display system 100H of the present embodiment. FIG. 26 is a schematic side view showing the display system 100H of the present embodiment. The present embodiment is different from the seventh embodiment in that an optical element OE includes a retardation element.

The optical element OE includes a retardation element 41 and a polarizer 51. The retardation element 41 is, for example, a λ/2 plate described in the first embodiment.

The display panel PNL1, the retardation element 41, the polarizer 51, and the display panel PNL2 are provided to be aligned in this order in the third direction Z. The retardation element 41 faces each of the main surface F1 of the array substrate AR1 and the polarizer 51, as shown in FIG. 26. In other words, the retardation element 41 is provided between the array substrate AR1 and the polarizer 51. The retardation element 41 may have a structure of being bonded to the array substrate AR1 and the polarizer 51 or a structure of being provided to be separated from each of the array substrate AR1 and the polarizer 51 via an air layer.

The polarizer 51 faces each of the retardation element 41 and the main surface F14 of the counter-substrate CT2, as shown in FIG. 26. In other words, the polarizer 51 is provided between the retardation element 41 and the counter-substrate CT2. The polarizer 51 may have a structure of being bonded to the counter-substrate CT2 or a structure of being provided to be separated from the counter-substrate CT2 via an air layer.

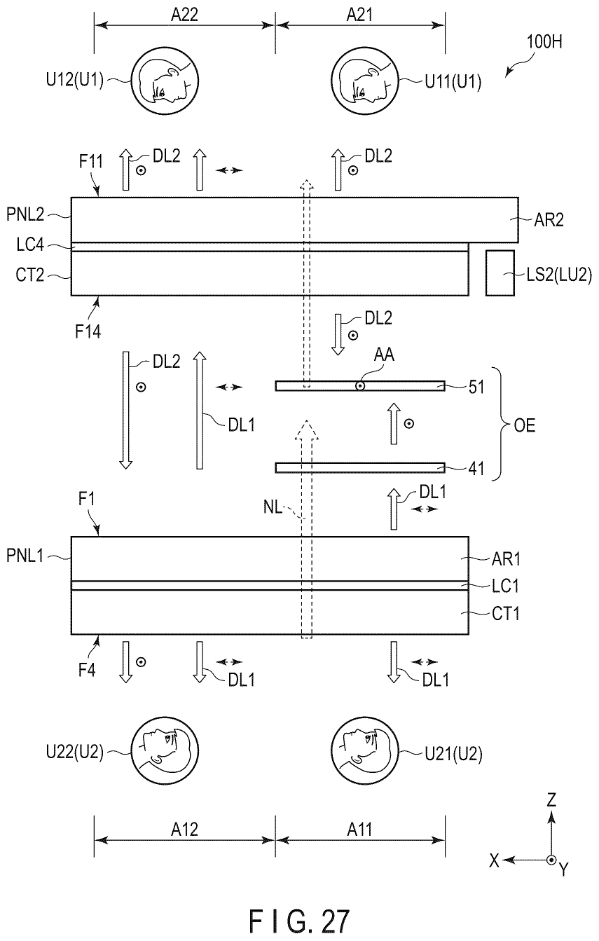

FIG. 27 is a diagram illustrating the display system 100H of the embodiment.

The user U11 viewing the first area A21 from the main surface F11 side and the user U21 viewing the first area A11 from the main surface F4 side are assumed.

The display light DL1 emitted from the display panel PNL1 is the first linearly polarized light. The display light DL1 emitted from the main surface F1 is converted into second linearly polarized light when transmitted through the retardation element 41.

The polarizer 51 has an absorption axis AA parallel to the second direction Y. For this reason, most of the light transmitted through the retardation element 41, of the display light DL1 emitted from the main surface F1, is absorbed into the polarizer 51 and is not transmitted through the display panel PNL2.

The display light DL2 emitted from the display panel PNL2 is second linearly polarized. The display light DL2 emitted from the main surface F14 is absorbed into the polarizer 51 and is not transmitted through the display panel PNL1.

For this reason, the display light DL1 from the display panel PNL1 is hardly visibly recognized by the user U11, and the display light DL2 from the display panel PNL2 is hardly visibly recognized by the user U21. In other words, the users U11 and U21 can hardly visibly recognize the display images of the display panels PNL1 and PNL2.

The same advantages as those of the seventh embodiment can be obtained in the present embodiment. The optical element OE in the present embodiment includes a retardation element 41 and a polarizer 51. For this reason, in the display panels PNL1 and PNL2, the display images of the display panels PNL1 and PNL2 are hardly displayed in the first areas A11 and A21. Therefore, both the users U11 and U21 can visibly recognize the display images in the first areas A11 and A21, respectively, while hardly visibly recognizing mirror images of the display images, and the visibility can be further improved.

### Tenth Embodiment

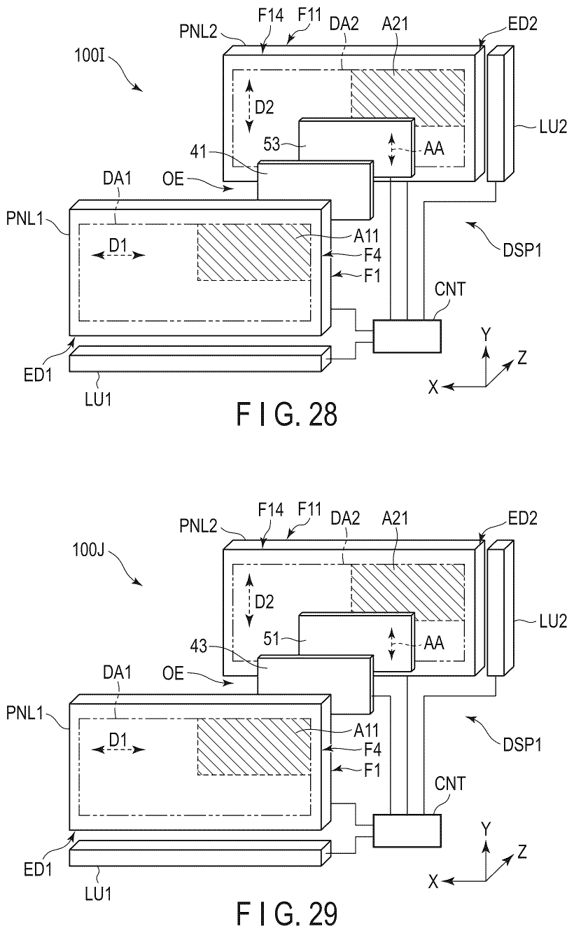

FIG. 28 is a diagram showing a configuration of a display system 1001 of the embodiment. The present embodiment is different from the ninth embodiment in a polarizer.

An optical element OE comprises a retardation element 41 and a polarizer 53. For example, the polarizer 53 is configured in the same manner as the polarizer described in the fourth embodiment. More specifically, the polarizer 53 is configured to switch the absorption mode and the transmission mode by a control signal from the controller CNT.

The same advantages as those of the ninth embodiment can be obtained in the present embodiment.

### Eleventh Embodiment

FIG. 29 is a diagram showing a configuration of a display system 100J of the embodiment. The present embodiment is different from the ninth embodiment in a retardation element.

An optical element OE comprises a retardation element 43 and a polarizer 51. For example, the retardation element 43 is configured in the same manner as the retardation element described in the third embodiment. The retardation element 43 is configured to switch the modulation mode and the non-modulation mode by a control signal from the controller CNT.

The same advantages as those of the ninth embodiment can be obtained in the present embodiment. Incidentally, the polarizer described in the fourth embodiment may be applied to the polarizer 51 in the present embodiment.

### Twelfth Embodiment

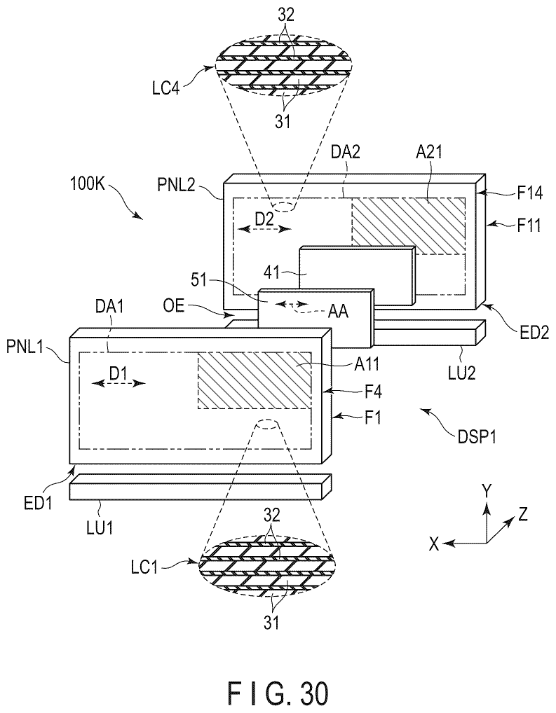

FIG. 30 is a diagram showing a configuration of a display system 100K of the present embodiment. The present embodiment is different from the ninth embodiment in that an extension direction D2 of polymer of a liquid crystal layer LC4 of a display panel PNL2 is parallel to the first direction X.

The optical element OE includes a retardation element 41 and a polarizer 51. The retardation element 41 is, for example, a λ/2 plate described in the first embodiment. The polarizer 51 is, for example, the polarizing film described in the first embodiment. The polarizer 51 has an absorption axis AA parallel to the first direction X. The polarizer 51 thereby absorbs first linearly polarized light.

The display panel PNL2 is configured in the same manner as a display panel PNL1. An extension direction of an end portion ED2 is parallel to an extension direction of an end portion ED1, as shown in FIG. 30. An extension direction D1 of polymer 31 of a liquid crystal layer LC1 is parallel to an extension direction D2 of polymer 31 of a liquid crystal layer LC4.

The display panel PNL1, the polarizer 51, the retardation element 41, and the display panel PNL2 are provided to be aligned in this order in the third direction Z. The polarizer 51 faces each of a main surface F1 of an array substrate AR1 and the retardation element 41. In other words, the polarizer 51 is provided between the array substrate AR1 and the retardation element 41. The polarizer 51 may have a structure of being bonded to the display panel PNL1 and the retardation element 41 or a structure of being provided to be separated from each of the display panel PNL1 and the retardation element 41 via an air layer.

The retardation element 41 faces each of the polarizer 51 and the main surface F14 of the counter-substrate CT2. In other words, the retardation element 41 is provided between the polarizer 51 and the counter-substrate CT2. The retardation element 41 may have a structure of being bonded to the display panel PNL2 or a structure of being provided to be separated from the display panel PNL2 via an air layer.

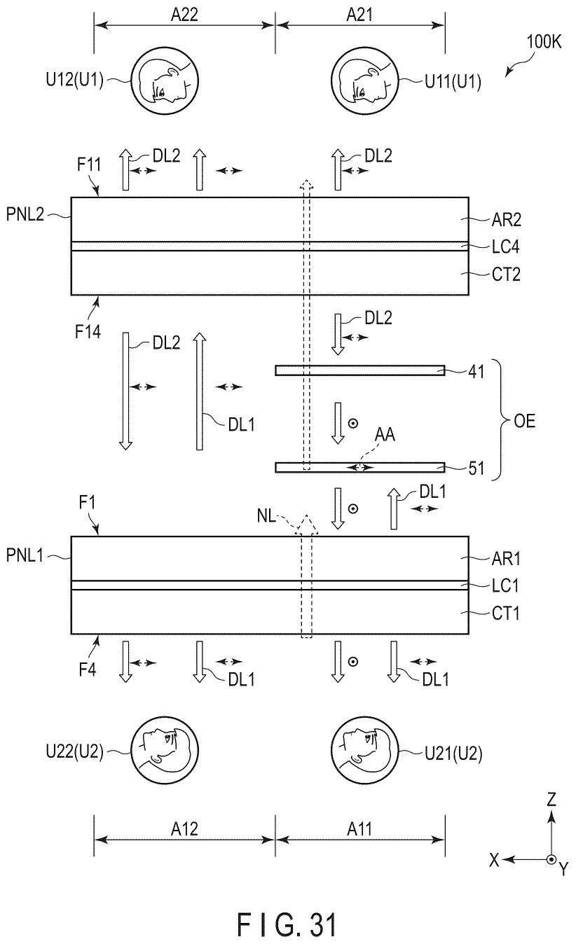

FIG. 31 is a diagram illustrating the display system 100K of the embodiment.

The user U11 viewing the first area A21 from the main surface F11 side and the user U21 viewing the first area A11 from the main surface F4 side are assumed.

The display light DL2 emitted from the display panel PNL2 is the first linearly polarized light. The display light DL2 emitted from the main surface F14 is converted into second linearly polarized light when transmitted through the retardation element 41.

The polarizer 51 has an absorption axis AA parallel to the first direction X. For this reason, the light transmitted through the retardation element 41, of the display light DL2 emitted from the main surface F14, is transmitted through the polarizer 51 and further transmitted through the display panel PNL1.

The display light DL1 emitted from the display panel PNL1 is the first linearly polarized light. Most of the display light DL1 emitted from the main surface F1 is absorbed into the polarizer 51 and is not transmitted through the display panel PNL2.

For this reason, the display light DL1 from the display panel PNL1 is hardly visibly recognized by the user U11, but the display light DL2 from the display panel PNL2 is visibly recognized by the user U21. In other words, the user U11 can hardly visibly recognize the display image of the display panel PNL1.

The same advantages as those of the ninth embodiment can be obtained in the present embodiment. In the present embodiment, the example in which the optical element OE includes the retardation element 41 and the polarizer 51 is disclosed, but the optical element OE may be configured not to include the retardation element 41.

Incidentally, the retardation element in the third embodiment may be applied to the retardation element in the present embodiment. The polarizer in the fourth embodiment may be applied to the polarizer in the present embodiment.

All of display systems that can be implemented by a person of ordinary skill in the art through arbitrary design changes to the display systems described above as embodiments of the present invention come within the scope of the present invention as long as they are in keeping with the spirit of the present invention.

Various modification examples which may be conceived by a person of ordinary skill in the art in the scope of the idea of the present invention will also fall within the scope of the invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display system comprising:
a first display panel having a first surface, a second surface on a side opposite to the first surface, and a first display area that is visibly recognizable from the first surface side and the second surface side; and
an optical element overlapping with a part of the first display area, wherein
the optical element includes at least one of a polarizer absorbing linearly polarized light and a retardation element imparting a ½-wavelength phase difference to transmitted linearly polarized light.

2. The display system of claim 1, wherein
the optical element is separated from the first display panel.

3. The display system of claim 1, wherein
transparency of an area which does not overlap with the optical element, in the first display area, is higher than transparency of an area which overlaps with the optical element, in the first display area, and
the area which overlaps with the optical element is smaller than the area which does not overlap with the optical element.

4. The display system of claim 1, wherein
the optical element includes the retardation element provided between the first surface and the polarizer.

5. The display system of claim 4, further comprising:
a first light source unit irradiating light to a first end portion of the first display panel, wherein
the first display panel further includes a first liquid crystal layer,
the first liquid crystal layer contains streaky polymer and liquid crystal molecules, and
the first end portion extends along a first extension direction of the polymer of the first liquid crystal layer.

6. The display system of claim 1, further comprising:
a second display panel having a third surface facing the first surface, a fourth surface on a side opposite to the third surface, and a second display area that is visibly recognizable from the third surface side and the fourth surface side, wherein
the optical element is provided between the first display panel and the second display panel, and overlaps with parts of the first display area and the second display area, and
the optical element includes the polarizer.

7. The display system of claim 6, wherein
the optical element further includes the polarizer.

8. The display system of claim 6, wherein
the optical element is separated from each of the first display panel and the second display panel.

9. The display system of claim 6, further comprising:
a first light source unit irradiating light to a first end portion of the first display panel; and
a second light source unit irradiating light to a second end portion of the second display panel, wherein
the first display panel further includes a first liquid crystal layer,
the second display panel further includes a second liquid crystal layer,
the first liquid crystal layer and the second liquid crystal layer contain streaky polymer and liquid crystal molecules,
the first end portion extends along a first extension direction of the polymer of the first liquid crystal layer,
the second end portion extends along a second extension direction of the polymer of the second liquid crystal layer, and
the first extension direction intersects the second extension direction.

10. The display system of claim 7, further comprising:
a first light source unit irradiating light to a first end portion of the first display panel; and
a second light source unit irradiating light to a second end portion of the second display panel, wherein
the first display panel further includes a first liquid crystal layer,
the second display panel further includes a second liquid crystal layer,
the first liquid crystal layer and the second liquid crystal layer contain streaky polymer and liquid crystal molecules,
the first end portion extends along a first extension direction of the polymer of the first liquid crystal layer,
the second end portion extends along a second extension direction of the polymer of the second liquid crystal layer, and
the first extension direction intersects the second extension direction.

11. The display system of claim 6, further comprising:
a first light source unit irradiating light to a first end portion of the first display panel; and
a second light source unit irradiating light to a second end portion of the second display panel, wherein
the first display panel further includes a first liquid crystal layer,
the second display panel further includes a second liquid crystal layer,
the first liquid crystal layer and the second liquid crystal layer contain streaky polymer and liquid crystal molecules,
the first end portion extends along a first extension direction of the polymer of the first liquid crystal layer,
the second end portion extends along a second extension direction of the polymer of the second liquid crystal layer, and
the first extension direction is parallel to the second extension direction.

12. The display system of claim 7, further comprising:
a first light source unit irradiating light to a first end portion of the first display panel; and
a second light source unit irradiating light to a second end portion of the second display panel, wherein
the first display panel further includes a first liquid crystal layer,
the second display panel further includes a second liquid crystal layer,
the first liquid crystal layer and the second liquid crystal layer contain streaky polymer and liquid crystal molecules,
the first end portion extends along a first extension direction of the polymer of the first liquid crystal layer,
the second end portion extends along a second extension direction of the polymer of the second liquid crystal layer, and
the first extension direction is parallel to the second extension direction.

13. The display system of claim 1, wherein
the retardation element is configured to switch a modulation mode of imparting a phase difference to transmitted linearly polarized light and a non-modulation mode of maintaining an oscillation plane of the transmitted linearly polarized light.

14. The display system of claim 1, wherein
the polarizer is configured to switch an absorption mode of absorbing linearly polarized light and a transmission mode of transmitting the linearly polarized light.

15. A display system comprising:
a display panel having a first surface, a second surface on a side opposite to the first surface, and a first display area that is visibly recognizable from the first surface side and the second surface side; and
glasses including a retardation element imparting a ½-wavelength phase difference to transmitted linearly polarized light and a polarizer absorbing linearly polarized light to which the phase difference is imparted.

16. The display system of claim 15, wherein
the retardation element is configured to switch a modulation mode of imparting a phase difference to transmitted linearly polarized light and a non-modulation mode of maintaining an oscillation plane of the transmitted linearly polarized light.

17. The display system of claim 16, further comprising:
a remote controller for switching the modulation mode and the non-modulation mode.

18. Glasses comprising:
a retardation element imparting a ½-wavelength phase difference to transmitted linearly polarized light; and
a polarizer transmitted through the retardation element to absorb linearly polarized light to which a phase difference is imparted.

19. The glasses of claim 18, wherein
the retardation element is configured to switch a modulation mode of imparting a phase difference to transmitted linearly polarized light and a non-modulation mode of maintaining an oscillation plane of the transmitted linearly polarized light.

20. The glasses of claim 19, further comprising:
a control unit for switching the modulation mode and the non-modulation mode, based on a control signal.
